(19) United States
(12) Patent Application Publication
(10) Pub. No.: US 2002/0075886 A1
(43) Pub. Date: Jun. 20, 2002

(54) Data communication network switching unit having a systolic ring structure

(76) Inventors: Jens P. Tagore-Brage, Frederiksberg (DK); Jens Carsten Michelsen, Skanor (SE); Ole Christian Andersen, Herlev (DK)

Correspondence Address: HARNESS, DICKEY & PIERCE, P.L.C., P.O. Box 8910, Reston, VA, 20195, US

(21) Appl. No.: 09/965,127

(22) Filed: Sep. 28, 2001

Related U.S. Application Data
(60) Provisional application No. 60/237,524, filed on Oct. 4, 2000.
(60) Provisional application No. 60/287,718, filed on May 2, 2001.

(51) Int. Cl. H04L 12/56

(52) U.S. Cl. 370/424; 370/403

(57) ABSTRACT

A switching unit and a method for operating the same as well as a device for use in the switching unit, where the switching unit comprises a ring-shaped bus for transporting the data packets and a daisy-chain type bus for transporting controlling device information for use in a later switching routing. The two busses are driven synchronously. This systolic nature of the busses ensures optimal bandwidth of the switching.

This invention relates to a switching unit, a method for switching a data packet, and a device for use in the unit. The invention in particular relates to a switching unit for switching incoming data packets between a first plurality of devices through a systolic, ring-shaped crossbar.

The general state of the art provides switching devices as essential elements of data communication networks such as local area networks, metropolitan area networks and wide area networks. The general architecture of the switching devices applies multiple stages of switches to route transactions between a source address and a destination address in a data communication network.

A switch may utilise crossbars implemented as a single matrix having a number of cross-points connecting inputs and outputs. The crossbar matrix potentially establishes point-to-point connections between any of the inputs of the crossbar to any of the outputs of the crossbar. This switch may ensure a safe transmission of a packet since the crossbar utilises point-to-point connections between input and output. However, as the number of inputs and outputs are increased in an implementation of the crossbar matrix switch, the design process significantly complicates. Thus the crossbar matrix switch is primarily useful for relatively small implementations. Further, the crossbar matrix switch may cause head of line blocking since the crossbar matrix switch during a transmission of a data packet may receive additional data packets, which cannot be passed through the crossbar matrix switch because the outputs are already busy receiving a data packet.

The switches may additionally be implemented as a series connection of matrix crossbars. This particular configuration of crossbars is known as space division switches. The space division switch allows the designer of the switch to reduce the number of total cross-points required in implementing a crossbar matrix switch. However, the head of line blocking may be further increased since more cross-points will be shared.

Conventional switching techniques are described in WO 99/39478 disclosing a packet switching fabric including a data ring, a control ring, a plurality of network links each coupled to at least one network node, and a plurality of switching devices coupled together by the data ring and the control ring. Each of the switching devices of the switching fabric perform queuing operations for controlling the transfer of data between switching devices thus establishing a distributed control system in the switching fabric. Thus, the lookup operations and the arbitration operations are distributed to the individual switching devices. The switching devices reserve bandwidth resources used in setting up and controlling the data ring channels. The allocation of bandwidth resources is generally implemented for a multi-chip switching system and enables cut through of a data transmission. That is, enabling a switching device to initiate a transmission of a data set before the switching device has received the full data set.

Other ring-shaped data busses or switches may be seen in:

“ARIS (ATM Ring Switch): An ATM Switch with Multicasting Capability”, Sukant K. Mohapatra et al, Proceedings of the Midwest symposium on circuits and systems, U.S., New York, IEEE, vol. Symp. 37, 3 August 1994, pages 1468-1471,

“The fast packet ring switch: A high-performance efficient architecture with multicast capability”, Moe Rahnema, IEEE Transactions on communications; U.S., IEEE Inc. New York, vol. 38, No. 4, 1 April 1990, Pp 539-545, EP-A-0996256 and 1003306,

WO00/52889, as well as

U.S. Pat. Nos. 4,612,635, 4,752,924, 4,982,400, 5,189,665, 5,305,311, 5,519,698, 5,669,508, 5,883,895, 6,246,692.

An object of the present invention is to implement a simple, fast and efficient switching unit for switching data packets, which switching unit utilises a central look up/arbiter function and comprises a ring-shaped crossbar utilising point to point series connections between a plurality of devices incorporated in the switching unit. As the bit rate of such switches increases, routing and general backend problems are alleviated by the present invention.

A particular advantage of the present invention is a significantly improved and simplified implementation since especially the circuit routing operation performed during the implementation process is greatly reduced and simplified relative to circuit routing operations required during the implementation of the general state of the art matrix crossbars.

A particular feature of the present invention is the provision of a switching unit, which effectively may be implemented as a single chip solution. In this solution, the individual devices of the switch may be identical, vastly alleviating the backend work in the workflow.

In a first aspect, the invention relates to a switching unit for switching a data packet, the switching unit comprising:

a plurality of devices each adapted to receive incoming data packets from an external network on an input port and transmit outgoing data packets through an output port to the external network,

means for interconnecting the plurality of devices in a ring configuration so as to enable communication of data between the plurality of devices,

means for determining, for each incoming data packet, a receiving device to receive and output the data packet, and to generate corresponding receiving device information, and

means for transporting the receiving device information from the determining means to the devices,

the devices being adapted to:

select one or more data packets to be switched, each data packet being held by a respective device, and

a first number of times:

forward, at least substantially simultaneously, at least part of each of the data packets and pertaining receiving device information to a next device along the interconnecting means,

receive, at least substantially simultaneously and from the interconnecting means, the at least part of the selected data packets and the pertaining receiving device information, and

determine, at least substantially simultaneously in each device having received at least part of a data packet, on the basis of the pertaining receiving device information, whether the at least part of the data packet is intended for the device and, if so, storing a copy of the at least part of the data packet in the device,

wherein:

the transporting means interconnects the determining means and the devices in a daisy chain manner, the determining means being positioned at one end of the daisy chain and a final device at another end thereof,

the determining means is adapted to output receiving device information for the devices a predetermined number of times and to perform each outputting at least substantially simultaneously with a forwarding step of the devices, and

the devices, except the final device, being adapted to:

receive receiving device information from a previous device or the determining means along the transporting means, the receiving being performed at least substantially simultaneously with the receiving of the at least part of the data packets, and

forward at least part of the received receiving device information to a subsequent device along the transporting means, the forwarding being performed at least substantially simultaneously with the forwarding of the at least part of the data packets.

Thus, in this embodiment, the devices are interconnected in a ring structure where the data is interchanged. In addition to that, the determining means are connected outside the ring but at one end of a daisy chain including also all the devices. In this manner, the communication on both data busses may be systolic and synchronized while still not loosing bandwidth. If the determining means were part of the circular bus, a clock cycle would be lost due to the fact that data would have to pass the determining means. In the present embodiment, one full circle on the data bus will enable the determining means to “ripple” new receiving device information down the daisy chain to all devices—for future use.

In the present context, a data packet may be any type of assembly of data. Normally, the data will conform to a standard, such as the Ethernet standard, IEEE 802.3, Sonet, ATM, or other types of standards defining the internal structure of the data. Also, the data packets may have any desirable size—or variable sizes. The present invention is optimally suited for actually switching fixed-size data cells, so data packets larger than this fixed size may be divided into smaller parts, which are then switched individually and reassembled after switching.

Also, in the present context, a port may be any type of input or output from the devices. The data transport via a port may or may not conform to a given standard. Normally, the communication will conform to a standard, and e.g. a MAC may be present at the port in order to define and conform to this standard. The port may be adapted to communicate on any type of communication medium, such as twisted pair conductors, coaxial conductors, optical fibres, wireless communication etc.

The external network may be any type of network ranging from a single computer to the WWW. It should be noted that the network needs not be interconnected at other positions than via the present switching unit. Also, the network and size thereof will normally vary from port to port of the switch.

The present “daisy chain” interconnection of the devices may, in fact, be a ring interconnection. However, any data transferred in any connection directly between the final device and the determining means need not be used.

Preferably, the determining means are adapted to output receiving device information the first number of times in order for the operation on the daisy chain and that on the ring structure to be fully synchronisable.

Preferably, the interconnecting means and transporting means comprise a plurality of parallel connections between the devices, such as where a first number of the parallel connections are adapted to transport the at least part of the data packets between the devices and where a second number of the parallel connections are adapted to transport the pertaining receiving device information between the devices. In a preferred embodiment, the number of parallel connections in the first number corresponds to a number of bits present in an at least part of a data packet—the at least parts of the data packets preferably having the same number of bits.

Normally, each of the devices is adapted to, when determining whether the at least part of the data packet is intended for the device, use only part of the receiving device information in the determination. In fact, different devices may be adapted to use different parts of the information in their respective determinations. In this manner, the receiving device information may actually comprise individual parts for each of the devices on the ring.

Preferably, the determining means comprise:

means for, on the basis of at least part of a data packet, providing receiving device identification, and

an arbiter adapted to:

receive the receiving device identification relating to a number of data packets,

select, on the basis of the receiving device identification, a switching order of the data packets, and

output to the transporting means receiving device information relating to data packets at least part of each of which may be transported on the interconnecting means at the same time.

Naturally, the determining means/arbiter may simply, for each output, output the full receiving device information for a number of devices. This would, however, require a relative wide bus—and is quite unnecessary. Preferably, the arbiter is adapted to output, each of the predetermined number of times, receiving device information for one device, where the receiving device information is output in an order corresponding to the order of the devices on the transport means. Due to the “rippling” effect, the receiving device information for use in the device the farthest away, along the daisy chain, from the arbiter should be sent first.

Preferably, the devices are adapted to select the one or more data packets to be switched in accordance with receiving device information received from the determining means. The receiving device information may also, for some or all devices, comprise information to the effect that no parts of incoming data packets are to be sent. Instead, dummy data may be sent—or no data at all. This could be the situation when too may devices wish to transmit data to a given device, which is not able to receive this much data at one time.

In the present context, “at least substantially simultaneously” will mean that it is intended that the procedures be performed at the same time. Latencies of different types may actually shift some processes in time.

One manner of synchronizing the individual steps would be to have the unit may further comprise means for receiving or providing a clocking signal having a number of timely spaced pulses, and wherein the devices may be adapted to perform, in each of the number of times, each receiving step in accordance with the same pulse(s), each forwarding step in accordance with the same pulse(s), and each determination step in accordance with the same pulse(s). Thus, all devices perform the same step at the same time. In that manner, when all devices transmit, receive, and analyse data at the same times, it is ensured that a given device is always ready for the data transmitted by another device. This helps to utilizing the bandwidth of the unit.

When the first number of times is equal to the number of devices on the interconnecting means, data may be forwarded a full circle on the ring and from one end of the daisy chain to the other. In the following, a sequence of this type will be called a super cycle.

In a preferred embodiment, the devices are adapted to perform a second number of super cycles each comprising the first number of times of the selecting, forwarding, receiving and determining steps, and wherein the devices in one super cycle are adapted to select the data packets in accordance with receiving device information output by the determining means in a previous super cycle.

The devices may be adapted to establish a priority for each incoming data packet. Also:

the devices may be adapted to establish, for each incoming data packet, control information relating to a destination address, a source device identity, and a priority, and to provide the determining means with the control information,

the determining means, in that situation, being adapted to provide the receiving device information on the basis of the control information.

In one preferred embodiment, the devices are also adapted to, the first number of times, alter the receiving device information received from the interconnecting means and forward the altered receiving device information to the subsequent device along the interconnecting means. Preferably, the receiving device information is a bit mask having a bit relate to each of the devices, and the devices are then adapted to alter the receiving device information by shifting the bit mask by a predetermined number of bits, preferably one bit. In that situation, each device may be adapted to determine that the at least part of the data packet is intended for the device when a bit at a predetermined position in the bit mask has a predetermined value. The altering may be a shifting or swapping of device specific parts of the receiving device information. Thus, in order for all devices to check the same position(s) in the receiving device information, the alteration may be the shifting of the information in steps of the size of the device specific information—preferably a single bit.

A second aspect of the invention relates to a switching unit for switching a data packet, the switching unit comprising:

a plurality of devices each adapted to receive incoming data packets from an external network on an input port and transmit outgoing data packets through an output port to the external network,

means for determining, for each incoming data packet, a receiving device to receive and output the data packet, and for generating corresponding receiving device information, and

means for interconnecting the plurality of devices in a ring configuration so as to enable communication of data between the plurality of devices,

means for transporting the receiving device information from the determining means to the devices,

the devices being adapted to:

select one or more data packets to be switched, each data packet being held by a respective device, and

a first number of times:

forward, at least substantially simultaneously, at least part of each of the data packets and pertaining receiving device information to a next device along the interconnecting means,

receive, at least substantially simultaneously and from the interconnecting means, the at least part of the selected data packets and pertaining receiving device information, and

determine, at least substantially simultaneously in each device having received at least part of a data packet, from the pertaining receiving device information, whether the at least part of the data packet is intended for the device and, if so, storing a copy of the at least part of the data packet in the device,

wherein the first number of times is identical to the number of devices.

Thus, data transported along the ring structure is transported a full circle. This is an advantage when, e.g. an additional element, such as a CPU, is connected to a device, and wherein the device is adapted to, on the basis of receiving device information received, determine whether the pertaining at least part of a data packet received is to be output by the output port of the device or to be transmitted to the additional element. In this situation, the device connected to the additional element, in order to communicate itself with that element, must either be adapted to communicate directly with the element (not desired due to a number of things) or, as is made possible in this aspect, simply put the data on the ring and then determine, when receiving the data again, that it should go to the element. In that manner, no crossing of data for that element needs take place between the ingress and egress parts of a device. This is also desired when at least one of the devices has a number of output ports. Thus, in that situation, preferably the at least one of the devices is adapted to forward all data packets received to the interconnecting means. Instead of crossing data from one port to another, the data crosses the ring structure and is treated as data from the other devices. This keeps the devices simple and takes away only little bandwidth on the ring structure.

In a third aspect, the invention relates to a device for use in the unit of the first aspect, the device comprising:

means for receiving at least part of a data packet and pertaining receiving device information from the interconnecting means,

means for determining, on the basis of the receiving device information, whether the at least part of the data packet is intended for the actual device,

means for copying the at least part of the data packet if the at least part of the data packet is intended for the actual device,

means for forwarding the at least part of the data packet and pertaining receiving device information to a subsequent device along the interconnecting means,

means for receiving receiving device information from the transporting means, and

means for forwarding at least part of the receiving device information along the transporting means, the device being adapted to perform the receiving steps simultaneously and the forwarding steps simultaneously.

Preferably, the means for determining whether the at least part of the data packet is intended for the actual device are adapted to perform the determination using only part of the receiving device information.

When the device further comprises means for altering the receiving device information received from the interconnecting means, the determination as to whether the at least part of the data packet is intended for this device may actually be identical in each of a number of interconnected devices while still ensuring that data for a given device reaches that device and not non-intended receivers.

As described above, the receiving device information may have a number of parts each intended for a device, and these parts may change positions within the information as a result of the altering.

In one situation, the receiving device information is a bit mask, and the altering means are adapted to alter the receiving device information by shifting the bit mask by a predetermined number of bits, such as a single bit. Then, the means for determining whether the data is intended for the device could be adapted to determine this when a bit in the bit mask at a predetermined position has a predetermined value.

A fourth aspect of the invention relates to a method of switching a data packet in a switching unit comprising:

a plurality of devices adapted to receive incoming data packets from an external network on an input port and transmit outgoing data packets through an output port to said external network,

means for determining, for each incoming data packet, a receiving device to receive and output the data packet and for generating corresponding receiving device information,

means for interconnecting the plurality of devices in a ring configuration so as to enable communication of data packets between the plurality of devices, and

transporting means interconnecting the determining means and the devices in a daisy chain manner, the determining means being positioned at one end of the daisy chain and a final device at another end thereof,

where each of the devices is adapted to:

receive at least part of a data packet and pertaining receiving device information from the interconnecting means,

determine, on the basis of the receiving device information, whether the pertaining at least part of the data packet is intended for the actual device,

copy the at least part of the data packet if the at least part of the data packet is intended for the actual device, and

forward the at least part of the data packet and pertaining receiving device information to a subsequent device along the interconnecting means,

the method comprising a super cycle comprising the steps of:

at least substantially simultaneously selecting one or more data packets to be switched, each data packet being held by a respective device, and

a number of times:

at least substantially simultaneously:

forward at least part of each of the data packets and pertaining receiving device information from one device to a next device along the interconnecting means,

output, from the determining means, receiving device information to a subsequent device along the transporting means, and

forward, in each device having received receiving device information from the transporting means, at least part of the received receiving device information to a subsequent device on the transporting means,

at least substantially simultaneously:

receive from the interconnecting means the at least part of the selected data packets and pertaining receiving device information, and

receive the receiving device information from the transporting means, and

at least substantially simultaneously, in each next device receiving at least part of a data packet, determine, on the basis of the pertaining receiving device information, whether the at least part of the data packet is intended for the actual device.

Again, a number of super cycles may be defined wherein, in one or more first super cycle(s), the determining means determines, on the basis of at least part of a number of data packets received by the devices, the corresponding receiving device information, and outputs receiving device information relating to data packets at least part of which may be transported simultaneously on the interconnecting means in a subsequent super cycle.

Preferably, the method comprises providing a clocking signal having a number of timely spaced pulses, and wherein:

in accordance with the same pulse(s), each device performs the forwarding steps and the determining means performs the outputting step,

in accordance with the same pulse(s), each device performs the receiving steps, and

in accordance with the same pulse(s), each device performs the determining step.

In this manner, the actions to be performed each of the number of times (of each super cycle) will be timed and synchronized by the clocking signal. Thus, on the interconnecting means, data is forwarded synchronously (systolic) as well as on the transporting means. This aids in attaining the maximum bandwidth on the data busses.

As mentioned above, preferably, the forwarding steps, receiving steps, and determining steps in a super cycle are each performed a number of times equal to the number of devices in the unit.

In another aspect, the invention relates to a method of switching a data packet in a switching unit comprising:

a plurality of devices adapted to receive incoming data packets from an external network on an input port and transmit outgoing data packets through an output port to said external network,

means for determining, for each incoming data packet, a receiving device to receive and output the data packet and for generating corresponding receiving device information, and

means for interconnecting the plurality of devices in a ring configuration so as to enable communication of data packets between the plurality of devices,

where each of the devices is adapted to:

receive at least part of a data packet and pertaining receiving device information,

determine, on the basis of the receiving device information, whether the pertaining at least part of a data packet is intended for the actual device,

copy the at least part of the data packet if the at least part of the data packet is intended for the actual device, and

forward the at least part of the data packet and pertaining receiving device information to a subsequent device along the interconnecting means,

the method comprising the steps of:

selecting, at least substantially simultaneously, one or more data packets to be switched, each data packet being held by a respective device, and

a number of times:

forwarding, at least substantially simultaneously, at least a part of each of the data packets and pertaining receiving device information from one device to a next device along the interconnecting means,

receiving, in the next devices and at least substantially simultaneously, the at least part of the selected data packets and pertaining receiving device information, and

determining, at least substantially simultaneously in each next device receiving at least part of a data packet, whether the at least part of the data packet is intended for the device and, if so, storing a copy of the at least part of the data packet in the device,

wherein the number of times equals the number of devices.

A sixth aspect of the invention relates to a switching unit for switching a data packet, the switching unit comprising:

a plurality of devices each adapted to receive incoming data packets from an external network on an input port and transmit outgoing data packets through an output port to the external network,

means for determining, for each incoming data packet, a receiving device to receive and output the data packet and for generating corresponding receiving device information, and

means for interconnecting the plurality of devices in a ring configuration so as to enable communication of data packets between the plurality of devices,

where each of the devices is adapted to:

receive at least part of a data packet and pertaining receiving device information along the interconnecting means from another device,

determine, on the basis of the receiving device information, whether the at least part of the data packet is intended for the actual device,

copy the at least part of the data packet if the at least part of the data packet is intended for the actual device,

alter the receiving device information, and

forward the at least part of the data packet and altered pertaining receiving device information to a subsequent device along the interconnecting means.

As described above, the altering of the receiving device information before forwarding to the next device has a number of advantages.

Preferably, all devices are adapted to perform, during the step of determining whether the at least part of the data packet is intended for the device, the same determination method, and even more preferably perform the determination on only a predetermined part of the receiving device information. Then, all devices could be adapted to perform the comparison on the information at the same position in the receiving device information.

In that situation, the predetermined part of the receiving device information could be a predetermined bit of the receiving device information, and the receiving device information could be a bit map and then all devices are preferably adapted to, during the altering step, shift the bit map a predetermined number of bits.

In fact, all devices could be adapted to have an identical operation—and all devices could actually be identical. This is advantageous also from a backend view during design of the unit.

Yet another aspect of the invention relates to a method of switching a data packet in a switching unit comprising:

a plurality of devices adapted to receive incoming data packets from an external network on an input port and transmit outgoing data packets through an output port to said external network,

means for determining, for each incoming data packet, a receiving device to receive and output the data packet and for generating corresponding receiving device information, and

means for interconnecting the plurality of devices in a ring configuration so as to enable communication of data packets between the plurality of devices,

transporting means interconnecting the determining means and the devices in a daisy chain manner, the determining means being positioned at one end of the daisy chain and a final device at another end thereof,

the method comprising, in each device, the steps of:

receive at least part of a data packet and pertaining receiving device information,

determine, on the basis of the receiving device information, whether the at least part of the data packet is intended for the actual device,

copy the at least part of the data packet if it is intended for the actual device,

alter the receiving device information received, and

forward the at least part of the data packet and altered pertaining receiving device information to a subsequent device along the interconnecting means.

Again, the devices could have the same operation, the same determination step, and the same altering step. In this manner, “the same” will mean that given the same input, the same output will be produced.

Actually, due to this operation, the devices may be identified and have their operation purely defined by their position on the data bus.

In a final aspect, the invention relates to a device for use in the unit according to the sixth aspect of the invention, the device comprising:

means for receiving at least part of a data packet and pertaining receiving device information,

means for determining, from the receiving device information, whether the pertaining at least part of the data packet is intended for the actual device,

means for copying the at least part of the data packet if the at least part of the data packet is intended for the actual device,

means for altering the receiving device received, and

means for forwarding the at least part of the data packet and altered pertaining receiving device information to a subsequent device.

In the following, a preferred embodiment of the invention will be described with reference to the drawing.

### BRIEF DESCRIPTION OF THE DRAWINGS

FIG. 1, shows a block diagram of a switching unit according to the preferred embodiment of the present invention.

FIG. 2, shows a block diagram of the switching unit of FIG. 1.

FIG. 3, shows a block diagram of a device connected to a crossbar in the switching unit of FIG. 1.

### DETAILED DESCRIPTION OF THE PRESENT INVENTION

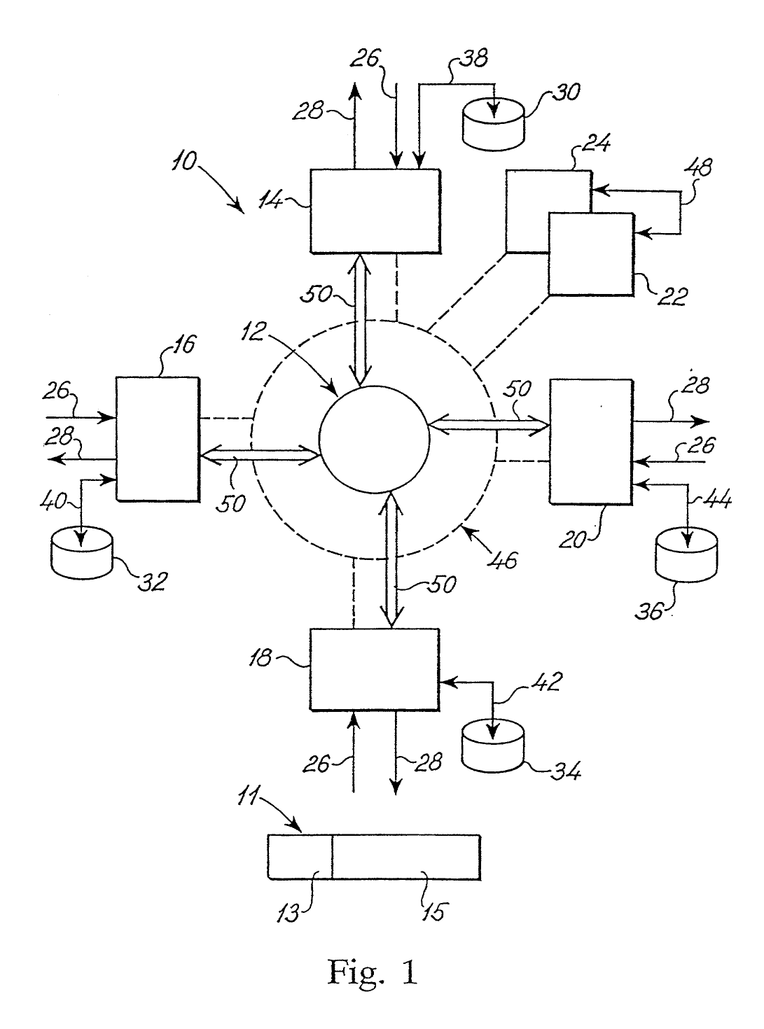

FIG. 1 shows a block diagram of a switching unit according to the preferred embodiment of the present invention, which switching unit is designated in its entirety by numeral 10. The switching unit 10 utilises a crossbar 12 for switching data packets 11 between devices 14, 16, 18 and 20, each data packet 11 comprising a header 13 and a payload 15. The header 13 may contain such information as destination address, source address and priority and the payload 15 may contain any data to be transmitted through a network.

The switching unit 10 comprises a crossbar 12 directing the data packets 11 received at any of the connected devices 14, 16, 18 or 20 to any or all of the connected devices 14, 16, 18 or 20; a lookup engine 22 (LU-engine) determining which of the devices 14, 16, 18 and/or 20 should receive the data packet 11; and an arbiter 24 determining from control information received from the LU-engine which of the devices 14, 16, 18 and/or 20 are to transmit and receive data packets 11 on the crossbar 12.

The LU-engine comprises a table or other data storage mapping external receiver addresses (such as MAC addresses or IP addresses) to internal receiving device identities—the devices via which the data packet may, in fact, reach its destination.

The data packets may be addressed to any specific device of the connected devices 14, 16, 18 or 20, addressed to a group of the connected devices 14, 16, 18 and/or 20 (multicasting), or alternatively addressed to all of the connected devices connected devices 14, 16, 18 and 20 (broadcasting).

Any number of devices 14, 16, 18 and/or 20 may be used in the switching unit 10. In the present embodiment, four devices 14, 16, 18 and 20 are described as being connected to the crossbar 12. In the preferred embodiment, actually 16 devices are used. However, the functionality is more easily understood with a fewer number of devices.

Each device 14, 16, 18 and 20 may further be connected to other switching units so as to receive and transmit data packets between further switching units. The communication within a switching unit is in this context referred to as internal communication and communication between switching units is in this context referred to as external communication.

The external communication is illustrated as inward and outward facing arrows 26 and 28 from each device 14, 16, 18 and 20. The external communication generally has to submit to a standard configuration, such as IEEE 802.3. However the internal communication, that is the switching of data packets over the crossbar 12, may be implemented in accordance with any customer design requirements.

As data packets 11 are received at the devices 14, 16, 18 and 20, the devices 14, 16, 18 and 20 save the data packets in local memories 30, 32, 34 and 36 associated with each of the devices 14, 16, 18 and 20 through respective connections 38, 40, 42 and 44.

Each of the devices 14, 16, 18 and 20 establishes a priority of the received packets and save the data packets in their respective local memories 30, 32, 34 and 36 in one of two queues—one for higher priority data and one for lower priority data.

The priority of a data packet stored in the local memories 30, 32, 34 and 36 is established by the devices 14, 16, 18 and 20 in accordance with the type of data packet e.g. new unknown data packet types are given high priority and known types of data packets are given a priority in accordance with a predefined priority level for the recognisable type. The various types of data packets may be recorded in local memories 30, 32, 34 and 36.

Upon request from the LU-engine, a device will generate a control header associated with the earliest received higher priority data packet or - if no higher priority data packets are stored, the earliest received lower priority data packet. The control header comprises such information as a destination and a source address copied from the header of the data packet and priority established by the receiving device on the basis of the contents of the entire data packet.

In an alternative embodiment, the communication of control headers between the devices and the LU-engine may be a slotted ring communication where each device has a slot on the ring. If a device has received a new data packet and the device's slot is empty, the device adds the control header in the slot. If the slot is not empty, the LU-engine and arbiter have sufficient control headers from that device. In that manner, the device will attempt to “saturate” the LU-engine and arbiter with headers—if it has any.

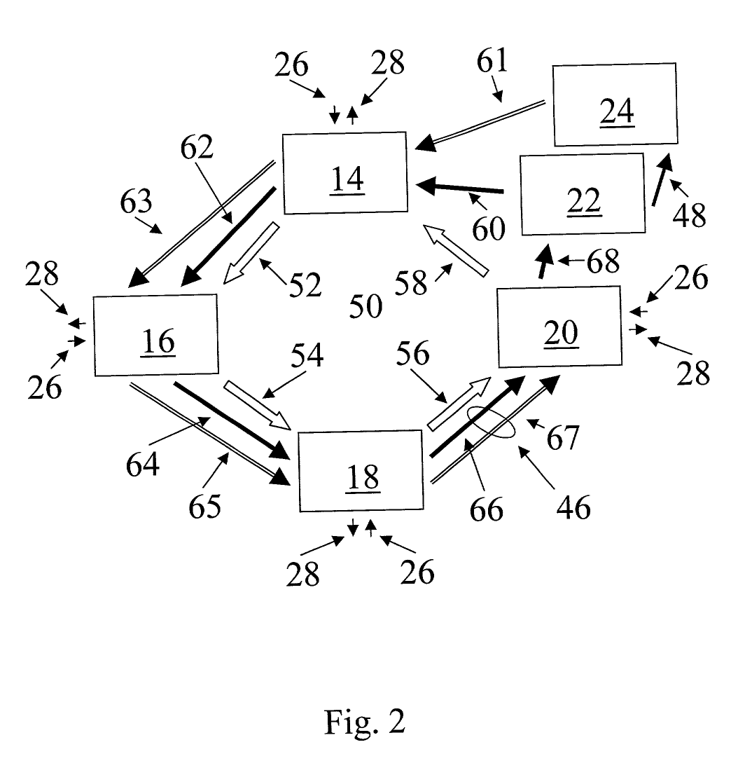

Each of the devices 14, 16, 18 and 20 transmits and receives data packets over the crossbar 12 having a plurality of connections 50 which, in FIG. 2, are denoted 52, 54, 56, and 58. These connections 50 are shown in FIG. 1 as bi-directional arrows, hence devices 14, 16, 18 and 20 both receive from and transmit to each other over the crossbar 12. A more detailed description of the internal communication between each of the devices 14, 16, 18 and 20 as well as the arbiter and LU-engine will be given below.

The arbiter 24 comprises, for each device, a buffer having four entries and in which controlling information received from the LU-engine 22 is present. When the buffer is not full for a given device, the arbiter 24 instructs the LU-engine 22 to request additional headers from the actual device. The requesting of the headers and the transmission of the headers (comprising DMAC, SMAC, length, priority, etc) is performed on lines 60, 62, 64, 66, and 68 forming part of a control connection 46.

In the alternative embodiment, the LU-engine will simply remove a header from the actual device's slot—if there is a header there.

The LU-engine 22 examines each control header and determines there from, which of the devices 14, 16, 18 and 20 should receive the associated data packets. The LU-engine 22 communicates, on the basis of the contents of each control header, forwarding information for each of the data packets received through a connection 48 to the arbiter 24. The forwarding information may contain information such as a bit mask identifying receiving device or receiving devices, source device, and priority of the associated data packet.

The forwarding information from the LU-engine will be put into the pertaining buffer of the arbiter—and the arbiter will instruct the individual devices to output packets/cells in the order in which the headers enter the buffer. Each device keeps a record of the order in which headers are transmitted to the LU-engine. That order is maintained when switching the corresponding data packets.

Thus, the order of packets output from the higher and lower priority queues to the output queue may differ from that in which the device received those packets, but once the data packets have entered the buffer of the arbiter, the ordering is not changed.

The arbiter therefore knows which data packet is first in all buffers—which data packets are next to be transmitted—and the priorities thereof.

The arbiter instructs the individual devices to transmit by forwarding bit masks over links 61, 63, 65, and 67 also forming part of the control connection 46.

In the present embodiment, the devices are able to store a single data packet during each clock cycle. In that situation, the arbiter ensures that two devices are not allowed to forward packets to the same device at the same time. If two devices wish to transmit packets to the same device, one device will be instructed to forward its packet in the next cycle and one will not be instructed to forward the packet until a following cycle.

The arbitration performed in the arbiter may be of any suitable kind. One manner is to generate bitmaps describing which devices are able to receive data and which device wishes to transmit to which device. Logical operations on these bitmaps will result in information relating to which devices may transmit in the next “turning of the wheel”. Such operations may be performed for each priority.

FIG. 2 shows a detailed block diagram of an implementation of the crossbar 12 in the switching unit 10 according to the present embodiment. The configuration of the internal communication 50 between the devices 14, 16, 18 and 20 connected to the switching unit 10 utilises the unidirectional series connections 52, 54, 56 and 58 connecting the devices 14, 16, 18 and 20 in a ring shaped configuration. These connections are 277 bit wide busses and are used for transporting the data packets (256 bits) and bit patterns (21 bits) in parallel between the devices.

FIG. 2 further shows that the control connection 46 comprises the series connection, 60, 62, 64, 66, and 68, of the LU-engine 22 and the devices 14, 16, 18 and 20. These connections are used by the LU-engine to request from the individual devices (controlled by the arbiter buffers not being full) the control header of a highest priority data packet (or if all packets are of the same priority, that which was received first). These headers are also transmitted via these connections. These connections are 62 bits wide.

The result of the arbitration is a number of bitmaps to be transmitted—one for each device. The bitmap for a device informs the device whether the next data packet to be transmitted can be transmitted—and the bitmap comprises the receiving device information. The bitmap comprises 21 bits comprising 16 bits where a “1” at a given position is a sign to a given device that the data is for that device. The additional bits are controlling bits instructing the device to a.o. forward the next data packet/cell or an idle cell (if the device is, in fact, not allowed to transmit data). These bitmaps are transmitted from the arbiter along connections 61, 63, 65, and 67 also forming part of the control connection 46. These connections are 21 bits wide in order to transfer the bitmaps in parallel.

The bitmaps output take into account not only which device(s) is/are to receive the corresponding data but also which device outputs the data. This is due to the fact that all devices analyse a single bit in the bit pattern—at the same position. Thus, the bit map forwarded for a predetermined device to receive the data will differ depending on which device transmits the data. Also, having received the bit map, a device will shift the bit map by one bit before transmitting it to the next device on the ring.

When a device receives a bitmap, the bitmap is added as a header to the data (the next data packet or an idle cell) and transmitted along the connections 52, 54, 56, and 58.

The presently preferred embodiment is adapted to handle Ethernet packets. Such packets have varying lengths (64-1522 bytes—and up to 64 kilo bytes) whereby the devices are adapted to subdivide these into fixed-size cells.

The control header transmitted to the LU-engine and further to the arbiter comprises information relating to the length of the packet whereby the arbiter is able to determine over how many cells the packet is transmitted. In that manner, the arbiter ensures that all cells of a data packet are transmitted between devices in order—even though it is not required that one cell is transmitted each super cycle (see below). Each cell comprises 256 bits so that it may be transmitted in parallel between the devices.

In this situation, the arbiter will keep transmitting the same bit mask to a device until all cells of a data packet have been transmitted. There is nothing preventing this transmission from being interrupted if higher priority data traffic so demands.

The switching unit 10 according to the preferred embodiment may be implemented on a single chip for performing switching operations for elements presented on the single chip e.g. separate sections of a chip each performing various or multiple operations on data which need to be transferred between sections. In fact, as will be clear from the following, all devices may be implemented identically, which greatly facilitates the development and manufacture of the present switch.

The actual timing of the switching is the following:

The operation is performed in super cycles being (in the illustrated embodiment having four devices) four clock cycles.

Independently of this clock, the arbiter constantly controls the LU-engine to request control headers in order to keep the arbiter buffers full.

During one super cycle, the arbiter will determine, from the forwarding information in its buffers which relates to the data packets which are the first to be transmitted from each device, which devices are allowed to forward the first packet in its output queue in a future super cycle. Also, the arbiter will generate corresponding bit patterns. In a next super cycle, the arbiter will forward these bitmaps to the devices—simultaneously with the shifting of previously determined data cells.

During the following super cycle, the selected devices will, on the basis of the bitmaps received in the previous super cycle, forward their data packet to the subsequent device which will forward its own, previous data packet, receive the new data packet, analyse it, and store a copy if the packet is for the relevant device—and amend the bit mask relating to the data packet prior to transmission. This is performed once every clock cycle in order for the data packets to be shifted a full circle during that super cycle. During this super cycle, the LU-engine and arbiter prepare the next super cycles by determining which data packets to transmit next and by forwarding bit patterns.

In this respect, the bitmap transmitted to a given device will take into account in which device it is—in order for the shifting (left or right) to bring the correct “0”'s and “1”'s to a predetermined position in the correct devices. In this manner, all devices may check the same position in the bitmap in order to determine whether the data is for the actual device.

In the preferred embodiment, as described above, 16 devices are actually used whereby the super cycle consists of 16 clock cycles—using a 125 MHz clock (clock cycle of 8 ns).

Table 1 below illustrates how the data packets are shifted from device to device over the crossbar 12 within the switching unit 10. The devices 14, 16, 18 and 20 each provide a data packet to the crossbar during the first cycle or the synchronization cycle. The device 14 adds a data packet (D14-rx-data) destined for device 18. This data packet is shifted to the next device in accordance with each new cycle i.e. during the second cycle to device 16 and during the third cycle to device 18. The data packets are shifted round the crossbar 12 concurrently with the shifting of an associated bit mask identifying receiving device or devices on the control connection 40, illustrated in table 1 in the destination field. When the data packet reaches a destined device, the destined device may remove itself as receiver of the data packet by altering the bit mask on the control connection 40. This is illustrated in table 1 as the data packet (D14-rx-data) during the third cycle reaches its destination, namely device 18, the device 18 saves the data packet (D14-rx-data) and alters the bit mask on the control connection 40. The following fourth cycle shows that the data packet (D14-rx-data) is shifted from device 18 to device 20 and the destination on the control connection 40 is None.

Alternatively, a data packet may be destined for more than one device. The device 16 adds a data packet (D16-rx-data) during the synchronization cycle, which data packet (D16-rx-data) is destined for devices 14 and 20. The data packet (D16-rx-data) reaches device 20 during the third cycle in which the device 20 saves the data packet (D16-rx-data) and alters the associated bit mask on the control connection 40 by removing itself as a destination. During the following cycle, the fourth cycle, the data packet (D16-rx-data) is further shifted to the device 14. The device 14 saves the data packet (D16-rx-data) during the fourth cycle.

TABLE 1

| | Data (DA) | | | | |
|---|---|---|---|---|---|
| Cycle | Destination (DE) | Device 14 | Device 16 | Device 18 | Device 20 |
| 1 | DA | D14-rx- | D16-rx- | D18-rx- | D20-rx- |
| | | data | data | data | data |
| | DE | D18 | D14, D20 | N/A | D16 |
| 2 | DA | D20-rx- | D14-rx- | D16-rx- | D18-rx- |
| | | data | data | data | data |
| | DE | D16 | D18 | D14, D20 | N/A |
| 3 | DA | D18-rx- | D20-rx- | D14-rx- | D16-rx- |
| | | data | data | data | data |
| | DE | N/A | D16 | D18 | D14, D20 |
| 4 | DA | D16-rx- | D18-rx- | D20-rx- | D14-rx- |
| | | data | data | data | data |
| | DE | D14 | N/A | None | None |

The arbiter 24 may disable transmission of data packets on to the crossbar 12 from any of the devices 14, 16, 18 and 20 if the receiving device is or receiving devices are unable to receive any data packets. In this case the device will place a dummy data packet on the crossbar 12—a dummy packet with no receiving device. Table 1 illustrates this by having device 18 adding during the first cycle a data packet which cannot be received by intended receiving device or devices, hence the destination address is set to N/A.

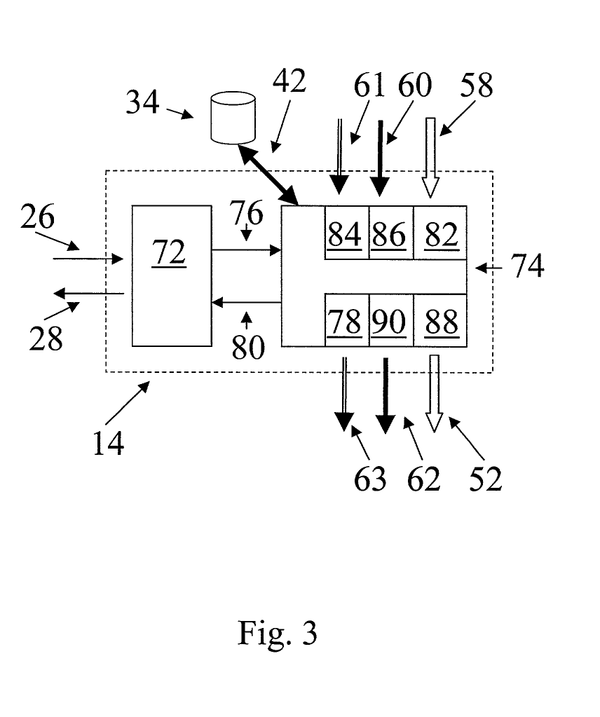

FIG. 3 shows a detailed block diagram of the device 14 connected to the crossbar 12 in the switching unit 10. The device 14 comprises a medium access controller 72 (MAC) for receiving data packets from and transmitting data packets to a multi-access channel network such as a local area network (LAN) or a metropolitan area network (MAN). The MAC 72 receives externally communicated data packets through the connection 26 and transmits data packets through the connection 28, while ensuring that the data packets avoid colliding with data packets already on the external multi-access channel network. The MAC 72 may utilise any protocol for controlling transmission on the multi-access channel network e.g. any IEEE standard or any particular custom or company requested standard. In an alternative embodiment of the switching unit 10, the device 14 may perform external point-to-point transmission through the connections 26 and 28 and therefore for this alternative embodiment a MAC is unnecessary in a device, since in point to point communications collisions are substantially avoided.

When the MAC 72 identifies a data packet for the switching unit 10 on the external network, that is, on the connections 26 or 28, the MAC 72 communicates the data packet to a device control module 74 through connection 76. The device control module 74 establishes a priority and temporarily stores the data packet in the local memory 34, which comprises the two priority queues. Additionally, the device control module 74 selects from the local memory 34 the highest priority data packet and forwards the pertaining control header on connection 62 via buffer 90 when having received a request on connection 60 via buffer 86. The control header may contain information such as the destination address, source address and the priority of the highest priority data packet. Subsequently the LU-engine receives this information from the control output buffer 90 and appropriately communicates enough information to the arbiter so that the arbiter may perform arbitration. On the other hand the MAC 72 receives data packets to be transmitted from the switching unit 10 through connection 80.

The data received in buffer 82 comprises a pertaining bit mask which the module 74 analyses (the value at a given position) in order to determine whether the data in the receiving buffer 82 is intended for the device 14. The data packet is communicated from the receiving input buffer 82 to a transmitting output 88 and the bit mask signal is altered. If the device control module 74 establishes from the bit mask signal that the data packet in the receiving input buffer 82 is intended for the device, the device control module 74 saves the data packet in the receiving input buffer 82 in the local memory 34 through connection 42.

The device control module 74 alters the bit mask signal in the input control buffer 82 before communicating the bit mask signal to the control output buffer 88. The alteration is accomplished by the device control module 74 shifting the bit mask signal either left or right in the input control buffer subsequent to the device control module 74 having established whether the associated data packet in the receiving input buffer 82 is intended for the device 14. Thus the device control module 74 of each of the devices connected to the crossbar shifts the bit mask signal in input control buffers by one bit before transmitting the bit mask signal and the associated data packet on to the crossbar. Hence enabling the next device control module of the next device connected to the crossbar to establish whether a data packet is intended for the device by examining the same bit position in the input control buffer 82. This simplifies the design procedure of the switching unit since all the devices connected to the crossbar are identical.

During each cycle, the device control module 74 receives, in a receiving input buffer 84, a bitmap for the next super cycle. This bitmap is forwarded unamended to buffer 78 and further along the connection 63 until the data on the ring 50 has been rotated a full circle. Then, the bitmaps on the connections 61, 63, 65, and 67 have been rotated to the correct devices. These bitmaps are then analysed in order for the device to determine whether to send a data cell or an idle cell. The pertaining cell is copied to the buffer 88 and the bit mask appended as a header. This data is then forwarded on the ring 50 in the following super cycle.

The local memories 30, 32, 34 and 36 connected to the devices 14, 16, 18 and 20 reduce head of line blocking. If a plurality of data packets is received at any of the devices 14, 16, 18 and 20, the device control module 74 will communicate the data packet to the local memory 34. The data packets having highest priority are transmitted at the earliest free synchronisation cycle and the data packets having lowest priority are transmitted when no high priority data packets are stored in any particular local memory of the local memories 30, 32, 34 and/or 36. The general order of transmitting high or low priority data packets from the local memories 30, 32, 34 and 36 may be made in accordance with any particular desired order such as first in first out or first in last out.

As described above the device 14 implementing the quality of service establishes the priority of the data packet. By default the device 14 designates high priority to incoming data packets. The general method for implementing quality of service is by analysing a data packet and increasing priority level of the data packet as the analysis progresses. In this embodiment of the present invention the device 14 initially provides the data packet with highest priority and as the data packet is analysed by the device 14 the priority level is lowered if the data packet is identified as being a non-high priority data packet. In one embodiment the device 14 initiates a tree structure analysis of the data packet. If the device 14 at the first level recognises the type of data packet the high priority is reduced otherwise the high priority is maintained. If the device 14 at the next level recognises the type of data packet the high priority level is reduced otherwise the high priority is maintained and so on. The device 14 thus provides unknown types of data packets with the highest priority and provides known types of data packets with priorities, which are in accordance with established priority for the particular type of data packet.

1. A switching unit for switching a data packet, the switching unit comprising:
a plurality of devices each adapted to receive incoming data packets from an external network on an input port and transmit outgoing data packets through an output port to the external network,
means for interconnecting the plurality of devices in a ring configuration so as to enable communication of data between the plurality of devices,
means for determining, for each incoming data packet, a receiving device to receive and output the data packet, and to generate corresponding receiving device information, and
means for transporting the receiving device information from the determining means to the devices,
the devices being adapted to:
select one or more data packets to be switched, each data packet being held by a respective device, and
a first number of times:
forward, at least substantially simultaneously, at least part of each of the data packets and pertaining receiving device information to a next device along the interconnecting means,
receive, at least substantially simultaneously and from the interconnecting means, the at least part of the selected data packets and the pertaining receiving device information, and
determine, at least substantially simultaneously in each device having received at least part of a data packet, on the basis of the pertaining receiving device information, whether the at least part of the data packet is intended for the device and, if so, storing a copy of the at least part of the data packet in the device,
wherein:
the transporting means interconnects the determining means and the devices in a daisy chain manner, the determining means being positioned at one end of the daisy chain and a final device at another end thereof,
the determining means is adapted to output receiving device information for the devices a predetermined number of times and to perform each outputting at least substantially simultaneously with a forwarding step of the devices, and
the devices, except the final device, being adapted to:
receive receiving device information from a previous device or the determining means along the transporting means, the receiving being performed at least substantially simultaneously with the receiving of the at least part of the data packets, and
forward at least part of the received receiving device information to a subsequent device along the transporting means, the forwarding being performed at least substantially simultaneously with the forwarding of the at least part of the data packets.

2. A unit according to claim 1, wherein the interconnecting means and the transporting comprise a plurality of parallel connections between the devices.

3. A unit according to claim 2, wherein a first number of the parallel connections are adapted to transport the at least part of the data packets between the devices and where a second number of the parallel connections are adapted to transport the pertaining receiving device information between the devices.

4. A unit according to claim 1, wherein each of the devices is adapted to, when determining whether the at least part of the data packet is intended for the device, use only part of the receiving device information in the determination.

5. A unit according to claim 1, wherein the determining means comprise:
means for, on the basis of at least part of a data packet, providing receiving device identification, and
an arbiter adapted to:
receive the receiving device identification relating to a number of data packets,
select, on the basis of the receiving device identification, a switching order of the data packets, and
output to the transporting means receiving device information relating to data packets at least part of each of which may be transported on the interconnecting means at the same time.

6. A unit according to claim 5, wherein the arbiter is adapted to output, each of the predetermined number of times, receiving device information for one device, where the receiving device information is output in an order corresponding to the order of the devices on the transport means.

7. A unit according to claim 1, wherein the devices are adapted to select the one or more data packets to be switched in accordance with receiving device information received from the determining means.

8. A unit according to claim 1, further comprising means for receiving or providing a clocking signal having a number of timely spaced pulses, and wherein the devices are adapted to perform, in each of the number of times, each receiving step in accordance with the same pulse(s), each forwarding step in accordance with the same pulse(s), and each determination step in accordance with the same pulse(s).

9. A unit according to claim 8, wherein the devices each are adapted to perform the receiving, forwarding and determination steps relating to one of the first number of times, in correlation to the same pulse.

10. A unit according to claim 1, wherein the first number of times is equal to the number of devices on the interconnecting means.

11. A unit according to claim 1, wherein the devices are adapted to perform a second number of super cycles each comprising the first number of times of the selecting, forwarding, receiving and determining steps, and wherein the devices in one super cycle are adapted to select the data packets in accordance with receiving device information output by the determining means in a previous super cycle.

12. A unit according to claim 1, wherein the devices are adapted to establish a priority for each incoming data packet.

13. A unit according to claim 1, wherein:
the devices are adapted to establish, for each incoming data packet, control information relating to a destination address, a source device identity, and a priority, and to provide the determining means with the control information,
the determining means being adapted to provide the receiving device information on the basis of the control information.

14. A unit according to claim 1, wherein the devices are also adapted to, the first number of times, alter the receiving device information received from the interconnecting means and forward the altered receiving device information to the subsequent device along the interconnecting means.

15. A unit according to claim 14, wherein the receiving device information is a bit mask having a bit relate to each of the devices, and wherein the devices are adapted to alter the receiving device information by shifting the bit mask by a predetermined number of bits.

16. A unit according to claim 15, wherein each device is adapted to determine that the at least part of the data packet is intended for the device when a bit at a predetermined position in the bit mask has a predetermined value.

17. A switching unit for switching a data packet, the switching unit comprising:
a plurality of devices each adapted to receive incoming data packets from an external network on an input port and transmit outgoing data packets through an output port to the external network,
means for determining, for each incoming data packet, a receiving device to receive and output the data packet, and to generate corresponding receiving device information, and
means for interconnecting the plurality of devices in a ring configuration so as to enable communication of data between the plurality of devices,
means for transporting the receiving device information from the determining means to the devices,
the devices being adapted to:
select one or more data packets to be switched, each data packet being held by a respective device, and
a first number of times:
forward, at least substantially simultaneously, at least part of each of the data packets and pertaining receiving device information to a next device along the interconnecting means,
receive, at least substantially simultaneously and from the interconnecting means, the at least part of the selected data packets and pertaining receiving device information, and
determine, at least substantially simultaneously in each device having received at least part of a data packet, from the pertaining receiving device information, whether the at least part of the data packet is intended for the device and, if so, storing a copy of the at least part of the data packet in the device,
wherein the first number of times is identical to the number of devices.

18. A unit according to claim 17, wherein an additional element, such as a CPU, is connected to a device, and wherein the device is adapted to, on the basis of receiving device information received, determine whether the pertaining at least part of a data packet received is to be output by the output port of the device or to be transmitted to the additional element.

19. A unit according to claim 17, wherein at least one of the devices has a number of output ports, the at least one of the devices being adapted to forward all data packets received to the interconnecting means.

20. A device for use in the unit according to claim 1, the device comprising:
means for receiving at least part of a data packet and pertaining receiving device information from the interconnecting means,
means for determining, on the basis of the receiving device information, whether the at least part of the data packet is intended for the actual device,
means for copying the at least part of the data packet if the at least part of the data packet is intended for the actual device,
means for forwarding the at least part of the data packet and pertaining receiving device information to a subsequent device along the interconnecting means,
means for receiving receiving device information from the transporting means, and
means for forwarding at least part of the receiving device information along the transporting means,
the device being adapted to perform the receiving steps simultaneously and the forwarding steps simultaneously.

21. A device according to claim 20, wherein the means for determining whether the at least part of the data packet is intended for the actual device are adapted to perform the determination using only part of the receiving device information.

22. A device according to claim 20, wherein the means for receiving and forwarding the at least parts of the data packets and receiving device information on the interconnecting means comprise means for receiving and forwarding a plurality of parallel connections of the interconnecting means.

23. A device according to claim 22, wherein the means for transmitting and receiving the at least parts of the data packets and pertaining receiving device information are adapted to transmit and receive the at least part of the data packet over a first number of the parallel connections between the devices and the receiving device information over a second number of the parallel connections between the devices.

24. A device according to claim 20, further comprising means for altering the receiving device information received from the interconnecting means.

25. A device according to claim 24, wherein the receiving device information is a bit mask, and wherein the altering means are adapted to alter the receiving device information by shifting the bit mask by a predetermined number of bits.

26. A device according to claim 25, wherein the means for determining whether the at least part of the data packet is intended for the actual device is adapted to determine this when a bit in the bit mask at a predetermined position has a predetermined value.

27. A method of switching a data packet in a switching unit comprising:
a plurality of devices adapted to receive incoming data packets from an external network on an input port and transmit outgoing data packets through an output port to said external network,
means for determining, for each incoming data packet, a receiving device to receive and output the data packet and for generating corresponding receiving device information,
means for interconnecting the plurality of devices in a ring configuration so as to enable communication of data packets between the plurality of devices, and
transporting means interconnecting the determining means and the devices in a daisy chain manner, the determining means being positioned at one end of the daisy chain and a final device at another end thereof,
where each of the devices is adapted to:
receive at least part of a data packet and pertaining receiving device information from the interconnecting means,
determine, on the basis of the receiving device information, whether the pertaining at least part of the data packet is intended for the actual device,
copy the at least part of the data packet if the at least part of the data packet is intended for the actual device, and
forward the at least part of the data packet and pertaining receiving device information to a subsequent device along the interconnecting means,
the method comprising a super cycle comprising the steps of:
at least substantially simultaneously selecting one or more data packets to be switched, each data packet being held by a respective device, and
a number of times:
at least substantially simultaneously:
forward at least part of each of the data packets and pertaining receiving device information from one device to a next device along the interconnecting means,
output, from the determining means, receiving device information to a subsequent device along the transporting means,
forward, in each device having received receiving device information from the transporting means, at least part of the received receiving device information to a subsequent device on the transporting means,
at least substantially simultaneously:
receive from the interconnecting means the at least part of the selected data packets and pertaining receiving device information, and
receive the receiving device information from the transporting means,
at least substantially simultaneously, in each next device receiving at least part of a data packet, determine, on the basis of the pertaining receiving device information, whether the at least part of the data packet is intended for the actual device.

28. A method according to claim 27, wherein the step of forwarding information along the interconnecting means comprises transmitting the information along a plurality of parallel connections between the devices.

29. A method according to claim 28, wherein the step of forwarding information along the interconnecting means comprises transmitting the data packets along a first number of the parallel connections between the devices and the receiving device information along a second number of the parallel connections between the devices.

30. A method according to claim 27, wherein the step of determining whether the at least part of the data packet is intended for the actual device uses only part of the pertaining receiving device information.

31. A method according to claim 27, comprising a number of super cycles wherein, in one or more first super cycle(s), the determining means determines, on the basis of at least part of a number of data packets received by the devices, the corresponding receiving device information, and outputs receiving device information relating to data packets at least part of which may be transported simultaneously on the interconnecting means in a subsequent super cycle.

32. A method according to claim 27, further comprising providing a clocking signal having a number of timely spaced pulses, and wherein:
in accordance with the same pulse(s), each device performs the forwarding steps and the determining means performs the outputting step,
in accordance with the same pulse(s), each device performs the receiving steps, and
in accordance with the same pulse(s), each device performs the determining step.

33. A method according to claim 27, wherein the forwarding steps, receiving steps, and determining steps in a super cycle are each performed a number of times equal to the number of devices in the unit.

34. A method according to claim 27, further comprising the step of a device establishing a priority for each data packet received by a device.

35. A method according to claim 27, further comprising the steps of:
the devices establishing, for each incoming data packet, control information for each incoming data packet, control information comprising information relating to a destination address, a source device identity, and a priority and providing the determining means with the control information,
the determining means providing the receiving device information on the basis of the control information received.

36. A method according to claim 27, further comprising the step of the devices altering the receiving device information received from the transporting means before forwarding the received information to the next device on the transporting means.

37. A method according to claim 36, wherein the receiving device information is a bit mask having a bit relate to each of the receiving devices of the plurality of devices, and wherein the step of altering the bit mask comprises shifting the bit mask by a predetermined number of bits.

38. A method according to claim 37, wherein the step of determining, on the basis of the pertaining receiving device information, whether the at least part of the data packet is intended for the device is performed on only part of the receiving device information.

39. A method of switching a data packet in a switching unit comprising:
a plurality of devices adapted to receive incoming data packets from an external network on an input port and transmit outgoing data packets through an output port to said external network,
means for determining, for each incoming data packet, a receiving device to receive and output the data packet and for generating corresponding receiving device information, and
means for interconnecting the plurality of devices in a ring configuration so as to enable communication of data packets between the plurality of devices,
where each of the devices is adapted to:
receive at least part of a data packet and pertaining receiving device information,
determine, on the basis of the receiving device information, whether the pertaining at least part of a data packet is intended for the actual device,
copy the at least part of the data packet if the at least part of the data packet is intended for the actual device, and
forward the at least part of the data packet and pertaining receiving device information to a subsequent device along the interconnecting means,
the method comprising the steps of:
selecting, at least substantially simultaneously, one or more data packets to be switched, each data packet being held by a respective device, and
a number of times:
forwarding, at least substantially simultaneously, at least a part of each of the data packets and pertaining receiving device information from one device to a next device along the interconnecting means,
receiving, in the next devices and at least substantially simultaneously, the at least part of the selected data packets and pertaining receiving device information, and
determining, at least substantially simultaneously in each next device receiving at least part of a data packet, whether the at least part of the data packet is intended for the device and, if so, storing a copy of the at least part of the data packet in the device,
wherein the number of times equals the number of devices.

40. A method according to claim 39, wherein an additional element, such as a CPU, is connected to a device, and wherein the device, on the basis of receiving device information received, determines whether the pertaining at least part of a data packet received is to be output by the output port of the device or to be transmitted to the additional element.

41. A method according to claim 39, wherein at least one of the devices has a number of output ports, the at least one of the devices forwarding all incoming data packets to the interconnecting means.

42. A switching unit for switching a data packet, the switching unit comprising:
a plurality of devices each adapted to receive incoming data packets from an external network on an input port and transmit outgoing data packets through an output port to the external network,
means for determining, for each incoming data packet, a receiving device to receive and output the data packet and for generating corresponding receiving device information, and
means for interconnecting the plurality of devices in a ring configuration so as to enable communication of data packets between the plurality of devices,
where each of the devices is adapted to:
receive at least part of a data packet and pertaining receiving device information along the interconnecting means from another device,
determine, on the basis of the receiving device information, whether the at least part of the data packet is intended for the actual device,
copy the at least part of the data packet if the at least part of the data packet is intended for the actual device,
alter the receiving device information, and
forward the at least part of the data packet and altered pertaining receiving device information to a subsequent device along the interconnecting means.

43. A switching unit according to claim 42, wherein all devices are adapted to perform, during the step of determining whether the at least part of the data packet is intended for the device, the same determination method.

44. A switching unit according to claim 42, wherein all devices are adapted to perform, during the step of determining whether the at least part of the data packet is intended for the device, the determination on only a predetermined part of the receiving device information.

45. A switching unit according to claim 44, wherein the predetermined part of the receiving device information is a predetermined bit of the receiving device information.

46. A switching unit according to claim 45, wherein the receiving device information is a bit map and wherein all devices are adapted to, during the altering step, shift the bit map a predetermined number of bits.

47. A switching unit according to claim 42, wherein all devices are adapted to have an identical operation.

48. A switching unit according to claim 42, wherein all devices are identical.

49. A method of switching a data packet in a switching unit comprising:
a plurality of devices adapted to receive incoming data packets from an external network on an input port and transmit outgoing data packets through an output port to said external network,
means for determining, for each incoming data packet, a receiving device to receive and output the data packet and for generating corresponding receiving device information, and
means for interconnecting the plurality of devices in a ring configuration so as to enable communication of data packets between the plurality of devices,
transporting means interconnecting the determining means and the devices in a daisy chain manner, the determining means being positioned at one end of the daisy chain and a final device at another end thereof,
the method comprising, in each device, the steps of:
receive at least part of a data packet and pertaining receiving device information,
determine, on the basis of the receiving device information, whether the at least part of the data packet is intended for the actual device,
copy the at least part of the data packet if it is intended for the actual device,
alter the receiving device information received, and
forward the at least part of the data packet and altered pertaining receiving device information to a subsequent device along the interconnecting means.

50. A method according to claim 49, wherein all devices perform, during the step of determining whether the at least part of the data packet is intended for the device, the same determination method.

51. A method according to claim 49, wherein all devices perform, during the step of determining whether the at least part of the data packet is intended for the device, the comparison on a predetermined part of the receiving device information, all devices performing the comparison at the same position in the receiving device information.

52. A method according to claim 51, wherein the predetermined part of the receiving device information is a predetermined bit of the receiving device information.

53. A method according to claim 52, wherein the receiving device information is a bit map and wherein all devices, during the altering step, shift the bit map a predetermined number of bits.

54. A switching unit according to claim 49, wherein all devices have an identical operation.

55. A method according to claim 49, wherein all devices perform, during the altering step, the same altering procedure.

56. A method according to claim 55, wherein the altering procedure is a shifting of a bit map a predetermined number of bits.

57. A device for use in the unit according to claim 43, the device comprising:
means for receiving at least part of a data packet and pertaining receiving device information,
means for determining, from the receiving device information, whether the pertaining at least part of the data packet is intended for the actual device,
means for copying the at least part of the data packet if the at least part of the data packet is intended for the actual device,
means for altering the receiving device received, and
means for forwarding the at least part of the data packet and altered pertaining receiving device information to a subsequent device.

58. A device according to claim 57, the device being adapted to perform the determination of whether the at least part of the data packet is intended for the device on only part of the receiving device information.

59. A switching unit according to claim 57, wherein the receiving device information is a bit map and wherein the device is adapted to, during the altering step, shift the bit map a predetermined number of bits.
